(19) United States
(12) Patent Application Publication
(10) Pub. No.: US 2024/0210171 A1
(43) Pub. Date: Jun. 27, 2024

(54) TOWED PLATFORM CURVED LINE SURVEYING USING FIBER OPTIC GYROSCOPIC SENSING

(71) Applicant: FNV IP B.V., Leidschendam (NL)

(72) Inventor: Chad PASTOR, Lafayette, LA (US)

(73) Assignee: FNV IP B.V., Leidschendam (NL)

(21) Appl. No.: 18/086,132

(22) Filed: Dec. 21, 2022

(51) Int. Cl. G01C 13/00; G01C 19/64

(52) U.S. Cl. CPC G01C 13/00; G01C 19/64

(57) ABSTRACT

Disclosed herein are systems and apparatuses for curved line surveying using a towed sensing apparatus with fiber optic gyroscopic heading determination. A method can include obtaining a plurality of surveying data inputs from one or more sensors of a towed sensing apparatus, the plurality of surveying data inputs obtained during a subsurface deployment of the towed sensing apparatus along a curved survey path and indicative of a seafloor measurement. A plurality of heading measurements indicative of an angular direction of the towed sensing apparatus can be obtained, wherein the plurality of heading measurements and the plurality of surveying data inputs are measured during the subsurface deployment. The plurality of surveying data inputs can be correlated with the plurality of heading measurements. A composite image of an area of seafloor along the curved survey path can be generated based on the plurality of surveying data inputs and the correlated heading measurements.

### FIELD

The present disclosure relates to an underwater surveying system and methods of use thereof. Specifically, the systems and techniques can be used to perform curved line surveying using a towed platform surveying device that includes a fiber optic gyroscope.

### BACKGROUND

Geophysical surveying often requires towing various sensors and/or sensor arrays using a vessel. For example, geophysical surveying can be performed based on towing one or more sensors behind a vessel, in front of a vessel, or a combination of the two. Based on sensor data obtained from the one or more sensors, an aerial image of the seafloor (or other surveying or imaging target) can be generated. For instance, an aerial image of the seafloor can be generated using a mosaicing process to stitch together aerial images obtained from different surveying passes performed by the tow vessel.

For example, one or more acoustic side-scan sonars can be provided on a platform, housing, etc., that is connected to a vessel via one or more cables or tethers. The platform or housing that includes the one or more acoustic side-scan sonars can also be referred to as a “fish” and/or as a “towfish.” The mosaicing process can be used to identify, classify, and count seafloor targets of various types such as fish traps, boulders, or other geo hazards. However, using conventional towed platforms (e.g., such as towfish) and conventional heading methods, such as Course Made Good (CMG), mother vessel heading, fish to mother vessel bearing, and/or magnetic-based heading devices can result in poor quality mosaics that contain false information and/or representations of the seafloor targets of interest. For example, the false information can lead to duplication of target counting and low-quality positioning due to poor-quality heading data.

Geophysical surveying can be performed by towing an array of sensors and/or related sensing equipment along a plurality of different paths. These paths may also be referred to as survey lines or survey paths. In existing approaches to geophysical surveying, sensor arrays are towed along a plurality of straight-line paths. Geophysical surveying based on straight-line survey paths can be inefficient when performing various surveys that are associated with curved lines or curved survey areas. For instance, existing approaches to geophysical surveying can approximate the surveying of a curved path or area by performing overlapping sets of straight-line surveys along the curve. Such an approach can be inefficient based on the time required to perform line turns by the survey vessel (e.g., tow vessel). Straight-line surveying of a curved path can also be inefficient based on the same patch of seafloor being surveyed multiple times, at each point of intersection between the overlapping sets of straight-line surveys. Straight-line surveying of a curved path can additionally be inefficient based on the amplification of various inaccuracies in the sensor data collected from the towed sensor array.

### SUMMARY

Aspects of the present disclosure include systems and techniques for curved line surveying using a towed sensing apparatus with fiber optic gyroscopic heading determination. A method can include obtaining a plurality of surveying data inputs from one or more sensors of a towed sensing apparatus, the plurality of surveying data inputs obtained during a subsurface deployment of the towed sensing apparatus along a curved survey path and indicative of a seafloor measurement. A plurality of heading measurements can be obtained, each heading measurement of the plurality of heading measurements indicative of an angular direction of the towed sensing apparatus, wherein the plurality of heading measurements and the plurality of surveying data inputs are measured during the subsurface deployment of the towed sensing apparatus. The plurality of surveying data inputs can be correlated with the plurality of heading measurements. A composite image of an area of seafloor along the curved survey path can be generated based on the plurality of surveying data inputs and the correlated heading measurements.

In another illustrative example, a system can include at least one processor and a memory storing instructions which when executed by the at least one processor, causes the at least one processor to: obtain a plurality of surveying data inputs from one or more sensors of a towed sensing apparatus, wherein the plurality of surveying data inputs is obtained during a subsurface deployment of the towed sensing apparatus along a curved survey path and are indicative of a seafloor measurement; obtain a plurality of heading measurements, each heading measurement of the plurality of heading measurements indicative of an angular direction of the towed sensing apparatus, wherein the plurality of heading measurements and the plurality of surveying data inputs are measured during the subsurface deployment of the towed sensing apparatus; correlate the plurality of surveying data inputs with the plurality of heading measurements; and generate a composite image of an area of seafloor along the curved survey path, based on the plurality of surveying data inputs and the correlated heading measurements.

In some aspects, the plurality of surveying data inputs is obtained based on towing the towed sensing apparatus along the curved survey path in a single continuous pass.

In some aspects, correlating the plurality of surveying data inputs with the plurality of heading measurements comprises correlating each surveying data input of the plurality of surveying data inputs with a corresponding heading measurement of the plurality of heading measurements.

In some aspects, correlating each surveying data input with a corresponding heading measurement comprises: identifying a particular heading measurement of the plurality of heading measurements as being associated with a same point in time as a respective surveying data input of the plurality of surveying data inputs; or generating an interpolated heading measurement for the respective surveying data input based on interpolating between a first heading measurement of the plurality of heading measurements that is temporally adjacent to and obtained prior to the respective surveying data input and a second heading measurement of the plurality of heading measurements that is temporally adjacent to and obtained subsequent to the respective surveying data input.

In some aspects, the plurality of heading measurements is obtained using a gyroscopic sensor array coupled to the towed sensing apparatus.

In some aspects, the gyroscopic sensor array comprises one or more of a fiber optic gyroscope (FOG) or a ring laser gyroscope (RLG).

In some aspects, the plurality of heading measurements is obtained using an Attitude and Heading Reference System (AHRS) coupled to the towed sensing apparatus.

In some aspects, the composite image is a mosaic image of the area of seafloor along the curved survey path.

In some aspects, generating the composite image of the area of seafloor is based on aligning the plurality of surveying data inputs to a common reference based on the correlated heading measurements.

In some aspects, the plurality of surveying data inputs is a plurality of side-scan sonar measurements obtained from a side-scan sonar array coupled to the towed sensing apparatus.

In some aspects, the towed sensing apparatus includes a plurality of different sensors; and the plurality of different sensors includes one or more of a side-scan sonar array, a transverse gradiometer array, a seismic sensor array, a sub-bottom profiler array, a water velocity sensor array, or an Acoustic Doppler Current Profiler (ADCP) array.

In some aspects, the plurality of surveying data inputs includes a first subset of surveying data inputs obtained using a first sensor type and a second subset of surveying data inputs obtained using a second sensor type.

In some aspects, generating the composite image of the area of seafloor comprises: correlating the first subset of surveying data inputs with the plurality of heading measurements and correlating the second subset of surveying data inputs with the plurality of heading measurements, wherein the first subset and the second subset are associated with the same correlated heading measurements; and generating the composite image of the area of seafloor based on aligning the first subset of surveying data inputs and the second subset of surveying data inputs using the same correlated heading measurements.

In some aspects, the curved survey path is associated with a first distal end and a second distal end opposite from the first distal end, the first distal end and the second distal end defining a longitudinal axis of the curved survey path; and a displacement of the curved survey path from the longitudinal axis varies along the length of the longitudinal axis from the first distal end to the second distal end.

Other advantages of the invention will become apparent from the following description taken in connection with the accompanying drawings, wherein is set forth by way of illustration and example an embodiment of the present invention.

### BRIEF DESCRIPTION OF THE DRAWINGS

In order to describe the manner in which the advantages and features of the present inventive concept can be obtained, reference is made to embodiments thereof which are illustrated in the appended drawings. Understanding that these drawings depict only exemplary embodiments of the present inventive concept and are not, therefore, to be considered to be limiting of its scope, the principles herein are described and explained with additional specificity and detail through the use of the accompanying drawings in which:

FIG. 1 illustrates a perspective view of an imaging system, including a towed apparatus connected to a vessel with a tow cable, according to an exemplary embodiment.

FIG. 2 illustrates a side view of the towed apparatus according to an exemplary embodiment.

FIG. 3 illustrates a front perspective view of the towed apparatus according to an exemplary embodiment.

FIG. 4 illustrates a back perspective view of the towed apparatus according to an exemplary embodiment.

FIG. 5 illustrates an example side-scan sonar image associated with magnetic heading data, according to some examples.

FIG. 6 is a diagram illustrating an example curved line surveying path that may be associated with a towed platform surveying device using fiber optic gyroscopic heading data, according to an exemplary embodiment.

FIG. 7 is a block diagram illustrating an example of a computing system for implementing certain aspects described herein.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

It will be appreciated that for simplicity and clarity of illustration, where appropriate, reference numerals have been repeated among the different figures to indicate corresponding or analogous elements. In addition, numerous specific details are set forth in order to provide a thorough understanding of the examples described herein. However, it will be understood by those of ordinary skill in the art that the examples described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Described herein is a surveying apparatus for creating an aerial image of the seafloor, along with one or more methods of use thereof. An example towed platform surveying apparatus and a curved line surveying method of use thereof will be described below in turn.

### Towed Platform Surveying Apparatus

An example towed platform surveying apparatus is described, which can include one or more sensors or sensor arrays and an Attitude and Heading Reference System (AHRS). In one illustrative example, the towed platform surveying apparatus can include one or more of a side-scan sonar array, a transverse gradiometer array, a high-resolution (and/or ultra-high resolution) seismic sensor array, a multi-beam sensor array, a sub-bottom profiler array, a water velocity sensor array, and/or an Acoustic Doppler Current Profiler (ADCP) array, among various others.

The apparatus can include a towed platform (e.g., a towfish) and a fiber optic gyroscope (FOG). In some aspects, the towfish is a shallow water towfish. The towfish includes a bracket and the FOG is mounted (e.g., removably coupled) to the bracket such that the towfish and the FOG are modular (e.g., interchangeable). For instance, a given towfish can be interchangeably coupled to various FOGs, via the bracket. Similarly, a given FOG can be interchangeably coupled to various towfish, via the bracket included on each towfish. For example, when an FOG fails, the inoperative FOG can be removed from the towfish and replaced with an operative FOG. Similarly, when a towfish fails, the FOG can be removed from the inoperative towfish and mounted to an operative towfish.

To conduct a survey to identify, classify, and/or count seafloor targets (e.g., fish traps, boulders, or other geohazards), the surveying apparatus is towed through the sea (e.g., submerged) behind a ship or other vessel. The vessel may be a manned or unmanned surface vessel (USV), a sub-surface vessel, such as a submarine vessel, either manned, or unmanned. In an embodiment, the vessel may be a submersed, semi-buoyant, or buoyant vessel. In an embodiment, the vessel may be any appropriate tow-vehicle.

During the survey, the shallow water towfish collects data of the seafloor and the FOG collects true North heading data. For instance, the true North heading data may be obtained directly using the FOG and may be stored in one or more raw data files (and/or other output data files generated by the FOG). In some aspects, the true North heading data may be obtained indirectly using the FOG, for instance based on one or more data processing operations to extract the true North heading data from a raw data file or other output data file generated by the FOG. Subsequently, after the survey is complete, overlapping images (e.g., side-scan sonar images are stitched together in a mosaicing process to create the aerial image of the seafloor. During this process, the true North heading data is used to create a highly accurate image of the seafloor and targets, which provides an accurate location of the targets.

The surveying apparatus described herein may provide significant benefits over conventional towfish. For example, the apparatus can significantly increase the accuracy of seafloor images, which can improve the ability to identify, classify, and/or count seafloor targets (e.g., geohazards). The accuracy of the images results, correspondingly, in a decrease in the amount of time required to complete mosaic post-processing. Accordingly, the increased accuracy can lead to cost savings (e.g., reduction in post-processing) for the project. Moreover, accurate images of the seafloor can be produced in a shorter turnaround time (e.g., project time compression).

The apparatus can significantly improve the accuracy of seafloor images over conventional towfish. For example, conventional towfish may include a magnetic compass that provides magnetic North heading data (e.g., heading relative to magnetic North). However, the magnetic North heading data is typically not suitable for the mosaicing process used to generate a composite image from a plurality of side-scan sonar images. For example, magnetic heading data is often inaccurate and cannot be used to automatically generate the composite or mosaiced seafloor survey image. In many cases, magnetic heading data must be manually reviewed and/or corrected when performing the mosaicing process, and in some examples, the mosaicing process itself may be performed manually (e.g., such as when the magnetic heading data is poor or inaccurate).

In general, the mosaicing process can be performed based on processing the data (e.g., geospatial images) collected by the conventional towfish. Therefore, a conventional method (e.g., Course Made Good (CMG), mother vessel heading, or fish to mother vessel bearing, etc.) is used to process the data to produce mosaics (e.g., multiple geospatial images stitched together). However, due to poor-quality heading data such as that often obtained using a magnetic compass, the conventional towfish and conventional methods can result in poor quality mosaics that include false information (e.g., duplicative/double targets, low-quality positioning). In some instances, a CMG-based heading determination can be inaccurate (e.g., off) by more than 25-degrees relative to the ground truth heading. For example, CMG-based heading determinations can be inaccurate due to lateral currents causing the towfish to yaw in a previously unmeasurable manner (e.g., yawing of the towfish is ignored in the CMG-based heading determination approach)

The presently disclosed apparatus can include a fiber optic gyroscope (FOG) that provides true North heading data (e.g., heading relative to true North), which increases the accuracy of the heading data (e.g., relative to existing magnetic compass heading data, CMG-based heading determinations, etc.). In some aspects, the fiber optic gyroscope can be provided as a heading, roll, and pitch sensing system. For instance, the fiber optic gyroscope can include one or more sensors for determining heading information, one or more sensors for determining roll information, and one or more sensors for determining pitch information. In some embodiments, some (or all) of the sensors included in the FOG can be used to obtain or otherwise determine multiple different measurements (e.g., one sensor can be used to determine heading and roll information; pitch and roll information; all three of heading, pitch, and roll information; etc.).

In some aspects, when the true North heading data is used to process the data collected by the shallow water towfish (e.g., to create geospatial images using a mosaicing process), the true North heading data can be used to accurately position various targets within the geospatial images and/or the resulting mosaic(s) generated from the geospatial images. In this manner, the data from the shallow water towfish can be better correlated with multibeam, sub-bottom, seismic, and transverse gradiometer (TVG) sensors. Moreover, the improved accuracy that can be obtained using the presently disclosed systems and techniques can be seen to improve a four-dimensional (4D) accuracy (e.g., a 3D accuracy as measured over time) from one year to the next related to scouring monitoring and sediment transport geohazards. For instance, 4D analysis (and improved accuracy thereof) can be used to verify the location(s) of pipelines, export main power cables, and/or inter-array cables (among various others) have not moved between from their corresponding location in one or more previous surveys (e.g., in the event that the pipelines, cables, etc., are uncovered due to scouring).

In one illustrative example, the FOG can be rigidly attached, coupled, or otherwise affixed to a towfish, such that the heading information of the FOG and the heading information of the towfish are the same. In particular, the FOG can be rigidly attached, coupled, or otherwise affixed to a towfish such that the heading information of the FOG and the heading information of one or more sonar transducers (e.g., side-scan sonar array) included on the towfish are the same. For instance, the FOG can be rigidly affixed to a shallow water towfish and used to obtain heading information corresponding to the shallow water towfish. The used of the rigidly affixed FOG can improve heading accuracy associated with the towfish (and/or side-scan sonar data collected using the towfish) by a magnitude of three times over the heading accuracy achieved with conventional towfish. Moreover, the heading data obtained using the rigidly affixed FOG can further be seen to be independent of magnetic effects such as geology, altitude from the seafloor, local ferrous objects, or towing distance from the vessel (e.g., each of which may be present in, and cause inaccuracies in, magnetic heading data). In some instances, the FOG can be accurate to within 0.5-degrees or less (e.g., the difference between the heading determined by or otherwise output by the rigidly affixed FOG and the ground truth heading can be less than 0.5-degrees). In some examples, the FOG can be accurate to within 0.1-degrees or less (e.g., the difference between the heading determined by or otherwise output by the rigidly affixed FOG and the ground truth heading can be less than 0.1-degrees). In this manner, the presently disclosed apparatus can be used to obtain highly accurate geospatial images, including accurate target locations.

The surveying apparatus can significantly reduce the amount of mosaicing effort (e.g., time) that is necessitated when using conventional towfish. As previously discussed, the poor-quality heading data associated with conventional towfish results in poor image quality such that, when multiple images are stitched together during the mosaicing process, false information (e.g., duplicative/double targets, low-quality positioning) appears. As a result, mosaic post-processing of side-scan sonar data (or other data collected using the towfish) conventionally requires human review of the data (e.g., quality control) and human manipulation of the data (e.g., data correction) to reconcile the false information and produce an acceptable mosaic. As a result, conventional mosaic post-processing can require a substantial amount of time and resources (both computational and human), especially in target rich seafloor areas.

As mentioned previously, the presently disclosed apparatus significantly reduces the mosaic post-processing time based on an FOG being rigidly affixed to a towfish and used to obtain highly accurate true North heading data. By rigidly affixing the FOG to the towfish, the heading data of the FOG can be treated as the same as the heading of the towfish. Based on the significantly improved accuracy of the FOG heading data the accuracy of downstream operations based on the FOG heading data can correspondingly be improved as well. For instance, the systems and techniques described herein can be used to obtain more accurate target locations for targets associated with or otherwise represented within the geospatial images. Thus, when multiple images are stitched together during the mosaicing process, the presence of false information can be reduced or eliminated entirely (e.g., the resulting mosaic image is accurate) such that the data correction aspect of the mosaic post-processing is reduced or eliminated. In at least one example, the surveying apparatus disclosed herein can eliminate the data correction aspect of mosaic post-processing such that post-processing involves only data review (e.g., quality control). In this manner, the presently disclosed apparatus automates at least a portion of the workflow required by conventional systems. In some examples, post-processing that previously required ten days to complete with data from a conventional towfish can be accomplished in less than one day using the surveying apparatus disclosed herein.

Correspondingly, the surveying apparatus can significantly reduce costs of mosaic post-processing that is necessitated when using conventional towfish. Cost savings can be realized as a result of the reduction in the mosaic post-processing time, as previously discussed, and the costs associated therewith. Moreover, project time compression (e.g., shorter turnaround time for surveying projects performed using the presently disclosed towfish with rigidly affixed FOG) can be realized due to the reduction in the mosaic post-processing time, which leads to more efficient (e.g., faster) delivery of finalized data (e.g., seafloor image(s) and/or side-scan sonar mosaic(s)).

As another example of benefits over conventional towfish, the presently disclosed surveying apparatus can enable curved line surveying, while maintaining heading accuracy. Typically, curved line surveying amplifies the accuracy issues (e.g., false information) associated with a conventional towfish. However, because the presently disclosed apparatus collects accurate heading data (e.g., true North heading data obtained using the rigidly affixed FOG), curved line surveying can be performed while the data correction aspect of the mosaic post-processing can be reduced or eliminated. In at least one example, post-processing involves only data review (e.g., quality control) because data correction (e.g., human manipulation of the data) is not necessary. In some examples, targets may be out-of-line by approximately 5 to 6 meters in a mosaic image generated using a conventional towfish and conventional heading determination techniques, while the same targets in an improved mosaic image generated using the systems and techniques described herein can be within 20 centimeters (e.g., out-of-line by 20 centimeters or less). Additionally, the presently disclosed apparatus can require less survey lines, which can translate into less post-processing and interpretation time, thereby speeding up the final deliverables. Additionally, the presently disclosed apparatus can enable surveying through smaller corridors, which can lead to project cost savings and project time compression.

As another example of benefits over conventional towfish, the presently disclosed surveying apparatus can be modular, such that the rigidly affixed FOG and the corresponding towfish for receiving the rigidly affixed FOG are interchangeable (e.g., modular) with respect to one another. For instance, the FOG can be externally mounted to the shallow water towfish, such that multiple FOGs and/or multiple towfish are interchangeable. Thus, if either the FOG or the towfish becomes inoperative (e.g., fails), the respective inoperative FOG or towfish can be removed and replaced with an operative FOG or towfish. Although the FOG does not include moving parts and, as a result, has no predicted life limitation, a FOG may fail over time. Therefore, the modular ability to replace a failed FOG is desirable. Conventional towfish, on the other hand, include an internal magnetic compass, which may not be interchangeable.

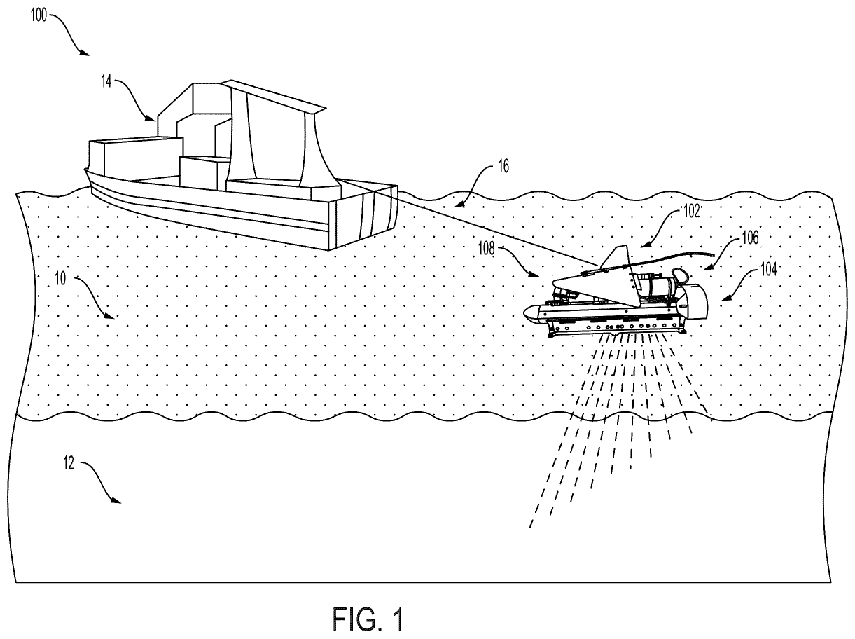

FIG. 1 illustrates a perspective view of an imaging system 100 for performing geophysical surveying or other marine search operations in a body of water 10 (e.g., an ocean or sea, lake, etc.). The system 100 includes a vessel 14 (e.g., boat, towing vessel, towing vehicle), a towing cable 16, and a towed apparatus 102. To deploy the towed apparatus 102 to perform a survey, one end of the towing cable 16 is connected (e.g., removably coupled) to the vessel 14 and the opposite end of the towing cable 16 is connected (e.g., removably coupled) to the towed apparatus 102. Subsequently, the towed apparatus 102 can be lowered into the body of water 10 and the vessel 14 is advanced such that the vessel 14 tows the towed apparatus 102 through the body of water 10 (e.g., with the towed apparatus 102 submerged within the body of water 10 during the towed operation). In other words, the towed apparatus 102 can be connected to the towing cable 16, which extends outward from the vessel 14 to the towed apparatus 102, such that the vessel 14 and towed apparatus 102 are moved in.

In one illustrative example, the towed apparatus 102 can be provided as a towfish (e.g., as described above). In some aspects, the towed apparatus 102 can be a side-scan sonar towfish, in which case the towed apparatus 102 can include a side-scan sonar device 104 and at least one gyroscopic sensor array 106 mounted thereto. In some embodiments, the towed apparatus 102 can include a depressor wing 108, which sheds water from the front of the towed apparatus 102 (e.g., sheds water from the end of the towed apparatus 102 that is closest to the vessel 14). The depressor wing 108 can additionally exert a downward force (e.g., away from the surface of the body of water 10, towards the seafloor 12) on the towed apparatus 102 as the towed apparatus 102 advances (e.g., is towed) through the body of water 10.

As the towed apparatus 102 advances (e.g., towed by the vessel 14), the side-scan sonar device 104 can collect data (e.g., to create geospatial images, side-scan sonar mosaics, etc.) of the seafloor 12. Simultaneously, or otherwise in conjunction with the data collection performed using side-scan sonar device 104, the gyroscopic sensor array 106 can collect movement and/or heading data (e.g., true North heading data). Subsequently, the side-scan sonar data and the gyroscopic heading data can be jointly processed (e.g., in a mosaicing process) to generate a mosaic side-scan sonar image of the seafloor 12. For instance, multiple geospatial images obtained using the side-scan sonar device 104 can be accurately stitched together (e.g., mosaiced) based on the true North heading data obtained using the gyroscopic sensor array 106. In this manner, the towed apparatus 102 can be used to produce an accurate aerial image of the seafloor 12, which can be used to accurately identify, classify, and/or count targets (e.g., geohazards, fish traps, boulders) on the seafloor 12.

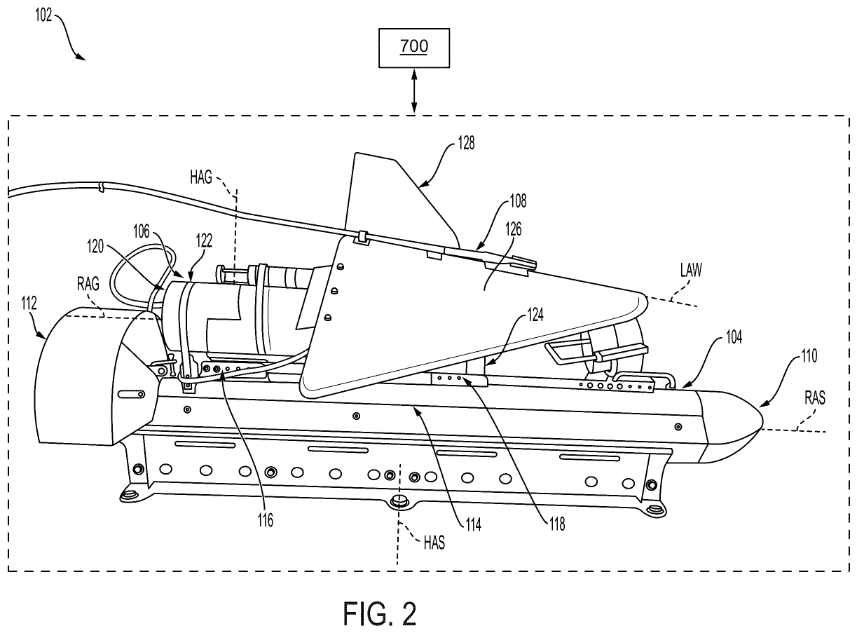

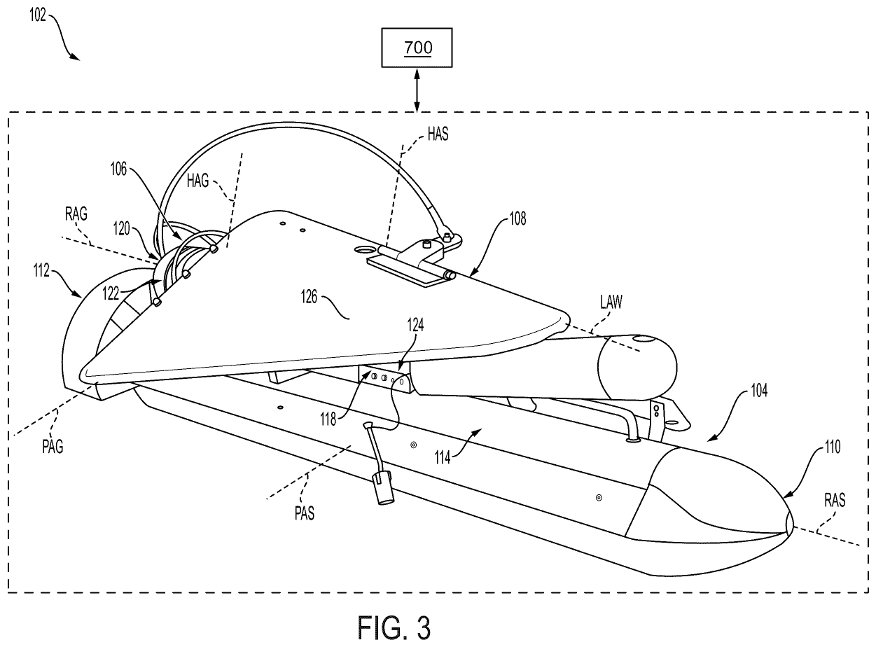

FIGS. 2-4 illustrate a side view, forward perspective view, and rear perspective view, respectively, of the towed apparatus 102 (e.g., also referred to as a “fish” or “towfish”) according to exemplary embodiments. As discussed previously, the towed apparatus 102 includes a side-scan sonar device 104 and a gyroscopic sensor array 106 mounted thereto. In some embodiments, as illustrated for example in FIGS. 2-3, the towed apparatus 102 can include a depressor wing 108. As the towed apparatus 102 is towed behind a vessel 14 to perform a survey, as illustrated for example in FIG. 1, the towed apparatus 102 can collect data (e.g., geospatial images and/or side-scan sonar images of the seafloor 14, true North heading data).

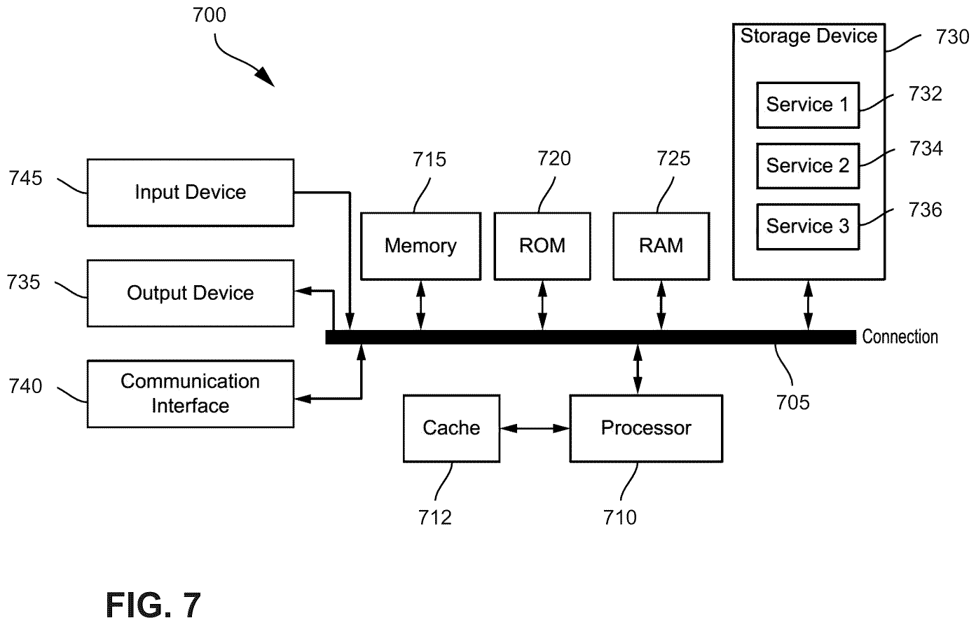

The disclosure turns now to the side-scan sonar device 104. As illustrated in FIGS. 2-4, the side-scan sonar device 104 can be configured to collect data (e.g., geospatial images) of the seafloor during a survey, during which time the towed apparatus 102 (and therefore side-scan sonar device 104) is submerged in a body of water 10 and towed behind a vessel 14. The side-scan sonar device 104 can be communicatively coupled to one or more data acquisition and/or data processing systems, which in one illustrative example can use the output data captured by side-scan sonar device 104 to generate mosaic side-scan sonar images of the seafloor. In some aspects, the side-scan sonar device 104 can be communicatively coupled to a computing system 700, as illustrated in FIG. 7 and discussed in greater depth below, such that the side-scan sonar device 104 can send data to the computing system 700 for one or more post-processing operations In some aspects, computing system 700 can be used to implement a data acquisition engine, a data processing engine, a mosaic processing engine, etc., as will also be described in greater depth below. For example, the side-scan sonar device 104 can include multiple sensors (e.g., provided via one or more transducer arrays) that emit sonar pulses (e.g., acoustic pulses) downward and measure the reflected pulse in order to image the seafloor (or other target of interest). For instance, the sensors included in side-scan sonar device 104 can receive and record (e.g., cross-track slices) the reflection (e.g., intensity) of the transmitted pulses off of the seafloor. The measured reflection data (e.g., the measured reflections of the transmitted sonar pulses) can be provided to a mosaicing engine (e.g., for instance implemented using the computing system 700 of FIG. 7). During a mosaicing process performed by the mosaicing engine, multiple cross-track slices can be stitched together to create an aerial image (e.g., mosaic) of the seafloor imaged by the side-scan sonar device 104.

As illustrated in FIGS. 2-4, the side-scan sonar device 104 can have a leading end 110 and a tail end 112 (which can include a tail cone), which can be oriented along a longitudinal axis of the side-scan sonar device 104. A housing 114 defines an internal compartment that houses internal electronics of the side-scan sonar device 104. In some embodiments, the side-scan sonar device 104 can include an internal, magnetic compass (e.g., in addition to the gyroscopic sensor array 106 that is rigidly coupled to the side-scan sonar device 104). In some examples, the side-scan sonar device 104 can be constructed of stainless steel, although various other constructions may also be utilized without departing from the scope of the present disclosure. In some embodiments, the side-scan sonar device 104 can be designed for shallow water operations. In some cases, side-scan sonar devices (e.g., side-scan sonar device 104) that are designed for shallow water operations may be relatively small devices, such that it is not feasible to mount a gyroscopic sensor array 106 inside a side-scan sonar device 104 designed for shallow water operation.

The side-scan sonar device 104 can include a longitudinal axis (also referred to as the roll axis RAS of the side-scan sonar device 104, as depicted in FIGS. 2-4), a transverse axis (also referred to as the pitch axis PAS of the side-scan sonar device 104, as depicted in FIGS. 2-4), and a normal axis (also referred to as the heading axis HAS of the side-scan sonar device 104, as depicted in FIGS. 2-4). The roll axis RAS and the pitch axis PAS are perpendicular to each other and are co-planar. The heading axis HAS is perpendicular to both the roll axis RAS and the pitch axis PAS.

A bracket 116 can be used to rigidly mount the gyroscopic sensor 106, via a removable (e.g., modular) coupling mechanism. In some examples, the bracket 116 can extend from a surface (e.g., top surface) of the side-scan sonar device 104. The bracket 116 can be laser-aligned with the side-scan sonar device 104 (e.g., mounted to the side-scan device 104 via a laser-alignment process) such that the bracket 116 is precisely positioned on the side-scan sonar device 104. For instance, based on the laser-alignment of the bracket 116 to the side-scan sonar device 104, the relative position of a gyroscopic sensor array 106 (e.g., coupled to the bracket 116) can be known with high accuracy with respect to the physical dimensions of the side-scan sonar device 104. In this manner, the gyroscopic sensor array 106 can be used to obtain highly accurate heading information for the side-scan sonar device 104 (e.g., accurate to within 0.5-degrees from the ground truth heading information of the side-scan sonar device 104). Moreover, because the bracket 116 is precisely positioned, the gyroscopic sensor array 106 can be modular (e.g., interchangeable) among one or more side-scan sonar devices 104.

In some embodiments, the bracket 116 includes two or more rails each having two or more apertures extending therethrough. The apertures can receive fasteners (e.g., bolts), which are used to removably couple the gyroscopic sensor array 106 to the side-scan sonar device 104. The bracket 116 provides rigidity, such that when the gyroscopic sensor array 106 is mounted to the side-scan sonar device 104, the gyroscopic sensor array 106 does not move (e.g., does not translate, does not rotate, etc.) relative to the side-scan sonar device 104. In one illustrative example, bracket 116 can be used to rigidly couple the gyroscopic sensor array 106 to the side-scan sonar device 104 in all three translation dimensions/directions and in all three rotation dimensions/directions. Additionally, as noted previously, the bracket 116 can provide a coupling mechanism that permits modularity among different side-scan sonar devices 104 and gyroscopic sensor arrays 106 that are configured for use with the bracket 116 (e.g., such as side-scan sonar devices 104 that include the bracket 116 and gyroscopic sensor arrays 106 that are configured for rigidly coupling to the bracket 116).

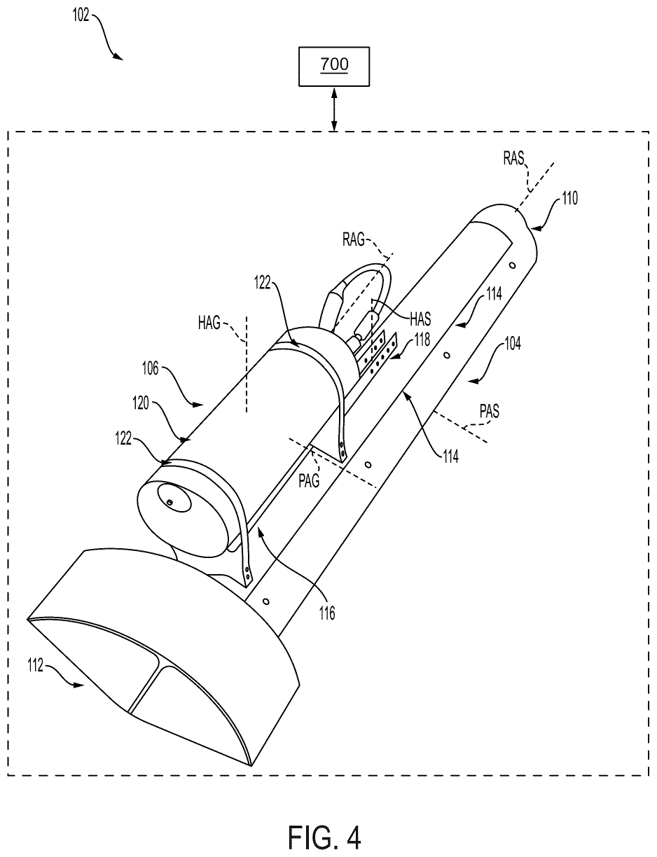

In some aspects, a second bracket 118, for mounting the depressor wing 108 to the side-scan sonar device 104, can extend from a surface (e.g., top surface) of the side-scan sonar device 104. In some embodiments, the second bracket 118 includes two or more rails each having two or more apertures extending therethrough. The apertures provided on the rails of the second bracket 118 can receive fasteners (e.g., bolts), which are used to removably couple The disclosure turns next to the gyroscopic sensor array 106, for example as depicted in FIG. 2 and FIG. 4. In one illustrative example, the gyroscopic sensor array 106 can be rigidly mounted to the side-scan sonar device 104 (e.g., via a rigid and removable coupling provided by the bracket 116) and configured to collect data (e.g., heading data of the towed apparatus 102) during towed survey operations. The gyroscopic sensor array 106 can be communicatively coupled to one or more data acquisition and/or data processing engines, which can be implemented based on the computing system architecture 700 depicted in FIG. 7 and described in greater depth below. In one illustrative example, the data acquisition and/or data processing engines communicatively coupled to the gyroscopic sensor array 106 can be the same as those communicatively coupled to the side-scan sonar device 104. For instance, the data acquisition and/or data processing engines can jointly process the side-scan sonar data (from side-scan sonar device 104) and the gyroscopic heading information (from gyroscopic sensor array 106) to thereby generate improved accuracy mosaic side-scan sonar images of the seafloor.

In some embodiments, the gyroscopic sensor array 106 can include or otherwise be associated with a housing 120 (e.g., enclosure). For instance, the gyroscopic sensor array 106 can be contained in (e.g., provided within an interior volume of) the housing 120. In some embodiments, the gyroscopic sensor array 106 can be aligned with the housing 120 (e.g., a laser alignment process can be used to guide the installation of gyroscopic sensor array 106 within the interior volume of housing 120). Accordingly, aligning the housing 120 with the side-scan sonar device 104 (e.g., as described above), can also serve to align the gyroscopic sensor array 106 with the side-scan sonar device 104, by virtue of the gyroscopic sensor array 106 having been previously aligned with the housing 120.

In some aspects, the gyroscopic sensor array 106 can include one or more gyroscopic sensors. For instance, the gyroscopic sensor array 106 can include one or more gyroscopic sensors provided as one or more internal gyroscopes. In one illustrative example, the gyroscopic sensor array 106 can collect at least heading information (e.g., true North), roll information, and pitch information. In some cases, the gyroscopic sensor array 106 can additionally collect inertial information. For example, the gyroscopic sensor array 106 may include one or more gyroscopic sensors for obtaining heading, pitch, and roll information, and may include one or more inertial measurement units (IMUs) for obtaining inertial or movement information. In some embodiments, the towed apparatus 102 can include a digital selector to select between collecting heading data from the magnetic internal compass of the side-scan sonar device 104 (e.g., magnetic North heading data) or from the externally mounted gyroscopic sensor array 106 (e.g., true North heading data).

In some aspects, the gyroscopic sensor array 106 gyroscope can be provided as a fiber-optic gyroscope (FOG) or can otherwise include one or more fiber-optic gyroscopes (FOGs). In some embodiments, the gyroscopic sensor array 106 can include an attitude and heading reference system (AHRS), which can provide true heading, roll, pitch, yaw, rates of turn and acceleration even in highly volatile environments. In some examples, an FOG can be an AHRS, and vice versa. In some examples, the AHRS includes an on-board processing system, which can provide attitude and heading information in real time. In some embodiments, the gyroscopic sensor array 106 does not collect positioning data. In some embodiments, the gyroscopic sensor array 106 does not include an inertial measurement unit (IMU). In some embodiments, the gyroscopic sensor array 106 can additionally, or alternatively, include a ring laser gyroscope (RLG). For example, the gyroscopic sensor array 106 can include one or more of an FOG or a ring laser gyroscope (RLG). An RLG can include a ring laser having two independent counter-propagating resonant modes over a same or shared path. A difference in phase between the two independent counter-propagating resonant modes over the same or shared path can be used to detect one or more rotations of the RLG. In some examples, the one or more detected rotations of the RLG can be used to determine heading information associated with a gyroscopic sensor array 106 that includes the RLG.

The gyroscopic sensor array 106 can include a longitudinal axis (also referred to as the roll axis RAG of the gyroscopic sensor array 106, as depicted in FIGS. 2 and 4), a transverse axis (also referred to as the pitch axis PAG of the gyroscopic sensor array 106, as depicted in FIGS. 2 and 4), and a normal axis (also referred to as the heading axis HAG of the gyroscopic sensor array 106, as depicted in FIGS. 2 and 4). The roll axis RAG and the pitch axis PAG are perpendicular to each other and are co-planar. The heading axis HAG is perpendicular to both the roll axis RAG and the pitch axis PAG.

In one illustrative example, the gyroscopic sensor array 106 can be externally mounted (e.g., removably coupled) to the side-scan sonar device 104. For instance, during installation, the gyroscopic sensor 106 can be laser-aligned with the side-scan sonar device 104 (e.g., mounted to the side-scan sonar device 104 via a laser-alignment process) such that the gyroscopic sensor array 106 is precisely positioned on the side-scan sonar device 104. For instance, based on the laser-alignment of the gyroscopic sensor 106 (and/or housing 120 thereof) to the side-scan sonar device 104, the relative position of the gyroscopic sensor array 106 with respect to the side-scan sonar device 104 can be known with high accuracy. In this manner, the gyroscopic sensor array 106 can be used to obtain highly accurate heading information of the side-scan sonar device 104 (e.g., accurate to within 0.5-degrees of the ground truth heading information of the side-scan sonar device 104). In some embodiments, the gyroscopic sensor array 106 can include a fault sensor (e.g., provided within the housing 120 of the gyroscopic sensor array 106), which can trigger a fault code if the gyroscopic sensor array 106 (e.g., housing 120) is not aligned within a pre-determined tolerance (e.g., the aforementioned accuracy of 0.5-degrees).

In some embodiments, one or more straps 122 (e.g., clamps) can be used to removably and rigidly couple the gyroscopic sensor array 106 to the side-scan sonar device 104. The one or more straps 122 can be wrapped around a portion of the circumference of the housing 120 of the gyroscopic sensor array 106 and attached with a fastener (e.g., screw) to the bracket 116 of the side-scan sonar device 104. In one illustrative example, when the gyroscopic sensor array 106 is mounted to the side-scan sonar device 104, the gyroscopic sensor array 106 is rigidly affixed to the side-scan sonar device 104, such that the gyroscopic sensor array 106 does not move (e.g., does not translate, does not rotate) relative to the side-scan sonar device 104 even when external forces are applied (e.g., as the towed apparatus 102 is moved through a body of water during a towed surveying operation). In some embodiments, the gyroscopic sensor array 106 is rigidly affixed to an outer surface (e.g., top surface) of the side-scan sonar device 104. In some embodiments, the gyroscopic sensor is rigidly affixed to an inner volume of the housing 120 (e.g., enclosure) and the housing 120 is rigidly affixed to the outer surface of the side-scan sonar device 104.

When the gyroscopic sensor array 106 is mounted to the side-scan sonar device 104, the heading axis HAG of the gyroscopic sensor array 106 can be parallel to the heading axis HAS of the side-scan sonar device 104. Similarly, the roll axis RAG of the gyroscopic sensor array 106 can be parallel to the roll axis RAS of the side-scan sonar device 104. Finally, the pitch axis PAG of the gyroscopic sensor array 106 can be parallel to the pitch axis PAS of the side-scan sonar device 104.

Because the gyroscopic sensor array 106 is rigidly affixed to the side-scan sonar device 104, the axes of the gyroscopic sensor array 106 (e.g., heading axis HAG, roll axis RAG, pitch axis PAG) are inhibited from moving (e.g., translating, rotating) with respect to the axes of the side-scan sonar device 104 (e.g., heading axis HAS, roll axis RAS, pitch axis PAS) when external forces are applied (e.g., when the towed apparatus 102 is advanced through a body of water, such as when performing a towed survey). In other words, as the towed apparatus 102 is advanced through the body of water, the heading axis HAG of the gyroscopic sensor array 106 remains parallel to the heading axis HAS of the side-scan sonar device 104. Similarly, the roll axis RAG of the gyroscopic sensor array 106 remains parallel to the roll axis RAS of the side-scan sonar device 104. Finally, the pitch axis PAG of the gyroscopic sensor array 106 remains parallel to the pitch axis PAS of the side-scan sonar device 104.

Because the gyroscopic sensor array 106 is removably coupled to the side-scan sonar device 104, the towed apparatus 102 is modular (e.g., a given side-scan sonar device 104 can be compatible with various different gyroscopic sensor arrays 106 in an interchangeable manner, and vice versa). In other words, the side-scan sonar device 104 and/or the gyroscopic sensor array 106 can be removed and replaced (e.g., swapped), via the bracket 116 previously described above. For example, the side-scan sonar device 104 or the gyroscopic sensor array 106 can be removed (e.g., decoupled from the rigid affixation between the two) when the respective side-scan sonar device 104 or gyroscopic senor array 106 is at or near the end of its service life and replaced with new or newer components. In one example, when a side-scan sonar device 104 fails, an operative gyroscopic sensor array 106 can be removed from the inoperative side-scan sonar device 104. Then, the operative gyroscopic sensor array 106 can be mounted to an operative (e.g., new or different) side-scan sonar device 104. In another example, when a gyroscopic sensor array 106 fails, the inoperative gyroscopic sensor array 106 can be removed from the operative side-scan sonar device 104. Then, an operative (e.g., new or different) gyroscopic sensor array 106 can be mounted to the operative side-scan sonar device 104.

Turning now to the depressor wing 108, as illustrated in FIGS. 2-3, the depressor wing 108 can be mounted (e.g., removably coupled) to the side-scan sonar device 104 and configured to exert a downward force on the apparatus 102 as it advances (e.g., is towed) through the body of water. For example, the depressor wing 108 can include a plate 124 with one or more apertures therethrough. The apertures of the plate 124 of the depressor wing 108 can be aligned with the apertures of the bracket 118 of the side-scan sonar device 104 and a fastener (e.g., bolt) can be advanced through the apertures to removably couple the depressor wing 108 to the side-scan sonar device 104. In some examples, the depressor wing 108 can be constructed of fiberglass.

The depressor wing 108 defines a longitudinal axis LAW, which, when the depressor wing 108 is mounted to the towed apparatus 102, is coplanar with both the roll axis RAS of the side-scan sonar device 104 and the roll axis RAG of the gyroscopic sensor array 106. The depressor wing 108 can include two members that each define a planar surface 126. Additionally, the depressor wing 108 can include a fin 128, as illustrated for example in FIG. 2, which extends vertically upward from the depressor wing 108. The fin 128 can be aligned (e.g., coplanar) with the longitudinal axis LAW of the depressor wing 108.

The longitudinal axis of the depressor wing 108 can define a wing angle, which is measured with respect to the angle between the longitudinal axis of the depressor wing 108 and either the roll axis RAS of the side-scan sonar device 104 or the roll axis RAG of the gyroscopic sensor array 106. The wing angle can be, for example, between 0-degrees and approximately 10-degrees. For example, the wing angle can be approximately 0-degrees, 1-degree, 2-degrees, 3-degrees, 4-degrees, 5-degrees, 6-degrees, 7-degrees, 8-degrees, 9-degrees, or 10-degrees. When the towed apparatus 102 is towed through the water, the depressor wing 108 sheds water from the front of the towed apparatus 102 (e.g., the end of the towed apparatus 102 that is nearest to the tow vessel). Additionally, the depressor wing 108 exerts a downward force on the towed apparatus 102 such that the towed apparatus 102 is towed at a greater depth (e.g., a greater submerged depth relative to the surface of the body of water). In other words, the depressor wing 108 can cause the towed apparatus 102 to be positioned, while under tow, at a location more vertically downward and less horizontally rearward relative to the tow vessel as compared to the location at which the towed apparatus 102 would otherwise stabilize in the absence of depressor wing 108 (e.g., due to tow speed, current, etc.).

### Curved Line Surveying

As noted previously, a mosaicing process can be used to stitch together aerial images that are collected or otherwise obtained from different surveying passes performed by a tow vessel (e.g., towing a towed platform with one or more sensor arrays for providing input data for the mosaicing process). Based on the mosaicing process, a composite mosaic image can be generated from the discrete aerial images associated with the plurality of different surveying passes. Existing approaches to geophysical surveying that use conventional towed platforms and/or that use conventional heading determination methods may result in the generation of poor-quality mosaics that contain false information and/or representations of the seafloor targets of interest.

For instance, mosaic images that are generated based on surveying data that is collected in combination with magnetic heading data, such as that obtained from a magnetic compass onboard or coupled to the towed platform, can include false information and other artifacts that can lead to duplication of target counting and low-quality positioning of targets due to poor-quality heading data, among other undesirable effects. There is a need for systems and techniques that can be used to obtain mosaic images of the seafloor having an improved quality and accuracy. There is also a need for systems and techniques that can generate mosaic images of the seafloor with greater efficiency, including without manual or human intervention as in existing approaches.

There is also a need for systems and techniques that can generate mosaic images that minimize or eliminate artifacts such as duplication of target objects and misalignment of adjacent surveying passes/survey lines. In one illustrative example, the systems and techniques described herein can be used to generate mosaic images of the seafloor by automatically correlating and aligning the discrete aerial images generated for each respective survey line of a plurality of survey lines, based on the improved accuracy heading data obtained using an AHRS and/or FOG, as previously described above.

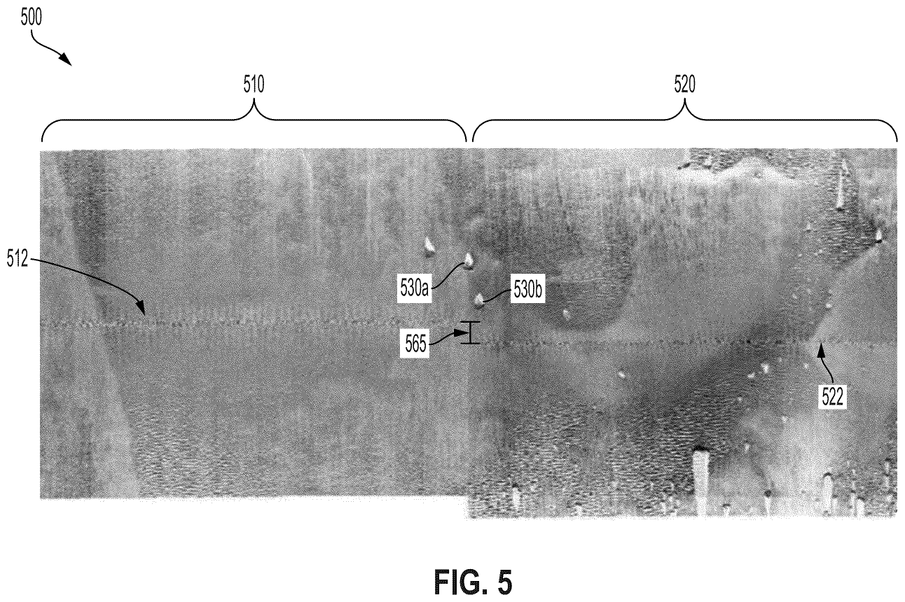

For example, FIG. 5 illustrates an example side-scan sonar image 500 that may be generated based on a mosaicing process that uses conventional approaches to obtaining heading data associated with the surveying apparatus. In other words, the side-scan sonar image 500 can be a mosaic image of the seafloor generated using an existing towed platform survey apparatus and/or an existing, relatively low-accuracy technique for determining heading information associated with the survey sensor data collection.

As illustrated, the mosaic side-scan sonar image 500 (e.g., also referred to as “mosaic image 500”) includes a first image portion 510 and a second image portion 520. The image portions 510, 520 can be generated using sensor data (in this case, side-scan sonar data) that is collected in or otherwise corresponds to two adjacent patches of the seafloor. For example, the first image portion 510 can be generated using sensor data corresponding to a first patch of the seafloor, and the second image portion 520 can be generated using sensor data corresponding to the patch of the seafloor that is immediately adjacent to the right of the first patch.

Notably, the underlying sensor data (e.g., side-scan sonar data) that is associated with and used to generate each image portion 510, 520 may be collected in a different surveying pass. For example, the first image portion 510 can be generated using sensor data that is collected by towing a towed platform survey apparatus along a first survey line, and the second image portion 520 can be generated using sensor data that is collected by towing the towed platform survey apparatus along a second survey line.

The mosaicing process used to generate the mosaic image 500 can attempt to align the two image portions 510, 520 such that no discontinuities are present in the resulting mosaic image 500 that is generated from the two image portions 510, 520. However, the mosaicing process is performed based on heading information that is obtained in conjunction with the underlying sensor data (e.g., side-scan sonar data) used to form each image portion 510, 520. Accordingly, low-quality and/or low accuracy heading information can result in a low-quality mosaic image with one or more visual discontinuities between the various image portions that are obtained on different surveying passes or lines.

For instance, the mosaic image 500 of FIG. 5 includes a vertical jump discontinuity 565 in which the center track survey line 512 of the first image portion 510 and the center track survey line 522 of the second image portion 520 are misaligned relative to one another. Such a misalignment can occur based on differences in the respective heading data collected in association with each of the surveying image portions 510 and 520. For example, the vertical jump discontinuity 565 may occur because the heading data associated with first image portion 510 is different from the heading data associated with the second image portion 520, even though the two image portions 510, 520 are collected along the same center line survey track (e.g., the mosaic image 500 should be properly rendered with the center track survey line 512 aligned with the center track survey line 514).

Conventional magnetic heading data and/or other existing approaches to heading determination can additionally, or alternatively, result in duplication discontinuities in which one or more target objects on the seafloor are depicted multiple times and in different locations in a generated mosaic image. For example, the mosaic image 500 include a first target object 530a (e.g., a rock on the seafloor) that is depicted in the first survey image portion 510 and a second target object 530b (e.g., the same rock) that is duplicated in the second survey image portion 520.

Here, the mosaic image 500 includes both the first target object 530a and the second target object 530b which is identical to the first target object 530a. Based on low-quality heading data associated with collection of the underlying survey data, the mosaicing process may be unable to properly align the first survey image portion 5510 with the second survey image portion 520—for instance, in a proper alignment, the second target object 530b would be overlaid on top of the first target object 530a such that only a single visual representation is included in the final mosaic image 500 (and at a single location, rather than two locations). In some aspects, duplicate objects can occur in a manner the same as or similar to that described above with respect to the vertical discontinuity error 565, which is due to the adjacent survey images being associated with different heading data despite being performed along the same center track survey line in reality. For instance, the vertical offset or separation between the first target object 530a and the second target object 530b can be the same as or similar to the size of the vertical jump discontinuity 565, as both errors can arise from the same underlying inconsistency between the heading data collected for the survey image 510 and the heading data collected for the survey image 520.

Inefficiencies in existing approaches to geophysical surveying can also arise when attempting to perform a survey along a curved survey path or over a curved survey area, as mentioned previously. For instance, in existing approaches to geophysical surveying, sensor arrays are towed along a plurality of straight-line paths. Geophysical surveying based on straight-line survey paths can be inefficient when performing various surveys that are associated with curved lines or curved survey areas. For example, existing approaches to geophysical surveying can approximate the surveying of a curved path or area by performing overlapping sets of straight-line surveys along the curve. Such an approach can be inefficient based on the time required to perform line turns by the survey vessel (e.g., tow vessel). Straight-line surveying of a curved path can also be inefficient based on the same patch of seafloor being surveyed multiple times, at each point of intersection between the overlapping sets of straight-line surveys. Straight-line surveying of a curved path can additionally be inefficient based on the amplification of various inaccuracies in the sensor data collected from the towed sensor array.

The systems and techniques described herein can be used to generate improved accuracy mosaic images of the seafloor along a curved survey path. In one illustrative example, the systems and techniques can automatically generate the improved accuracy mosaic images of the seafloor, based on using heading data obtained from an AHRS and/or FOG associated with a towed platform used to obtain the survey data (e.g., survey sensor data). In another illustrative example, the systems and techniques can generate improved accuracy mosaic images of the seafloor based on towing the towed apparatus 102 depicted in FIGS. 2-4 along a curved survey line (e.g., curved survey path).

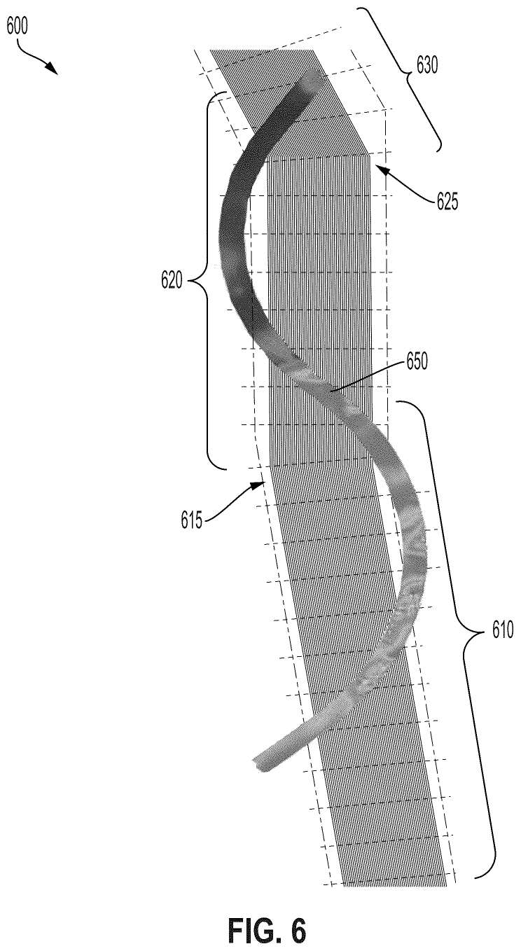

FIG. 6 is a diagram 600 illustrating an example curved line surveying path 650 that may be associated with a towed platform surveying device using fiber optic gyroscope (FOG) heading data and/or Attitude and Heading Reference System (AHRS) heading data, in accordance with some examples. Advantageously, the curved line surveying path 650 can be performed in one continuous surveying path (e.g., by both the tow vessel and the towed surveying apparatus, such as the towed apparatus 102 of FIGS. 2-4).

Also depicted in FIG. 6 are a plurality of conventional straight-line survey paths that may be performed to approximate the surveying of a curved path or area. For instance, the continuous curved survey line 650 may be used to survey a same or similar seafloor area as is obtained based on the plurality of conventional straight-line survey paths that are also shown in FIG. 6. The conventional straight-line survey paths can include multiple sets of straight-line survey paths, wherein each set includes a plurality of different straight survey lines.

For example, a first straight-line survey set 610 can include a first plurality of straight survey lines that are each approximately parallel to one another; a second straight-line survey set 620 can include a second plurality of straight survey lines that are each approximately parallel to one another; and a third straight-line survey set 630 can include a third plurality of straight survey lines that are each approximately parallel to one another.

Notably, when straight line survey sets 610, 620, 630 are used to approximate a curve or to otherwise approximate a curved survey line, each straight-line survey set may be associated with one or more intersection areas with the remaining straight line survey sets. For instance, the first straight line survey set 610 and the second straight line survey set 620 are associated with an intersection area 615, wherein the individual survey lines of the first set 610 each intersect with some (or all) of the individual survey lines of the second set 620 (and vice versa). Similarly, the second straight line survey set 620 and the third straight line survey set 630 are associated with an intersection area 625, wherein the individual survey lines of the second set 620 each intersect with some (or all) of the individual survey lines of the third set 630 (and vice versa).

The intersection areas 615 and 625 can make it difficult or impossible to generate accurate mosaic images from the sensor data associated with the plurality of straight-line surveys included in the three survey sets 610, 620, 630. For example, the vertical jump discontinuity and duplication of target objects depicted in FIG. 5 and described above may occur when attempting to mosaic only a first straight line survey (e.g., associated with the first image portion 510) and a second straight line survey (e.g., associated with the second image portion 520). Accordingly, when each respective survey line included in one of the survey sets 610, 620, 630 has multiple points of intersection or overlap with survey lines included in an adjacent set of survey lines, the issues and visual artifacts described above with respect to FIG. 5 can compound rapidly, often leading to unusable mosaic images and/or an inability to perform the mosaic processing.

In particular, a lack of consistency in the heading data associated with each of the plurality of straight survey lines depicted in FIG. 6 can result in numerous errors in the mosaic image, as it becomes difficult or impossible to establish a shared or common set of reference coordinates for aligning (e.g., mosaicing) the data collected in a given straight survey line with the data collected in the remainder of the plurality of straight survey lines.

In some examples, still further errors and visual artifacts may arise in the intersection areas 615 and 625 of the corresponding mosaic image(s) generated using conventional straight-line surveying to approximate a curved path. For instance, because each of the straight survey lines included in the intersection area 615 or 625 is collected at a discrete point in time (e.g., different point in time than any of the other straight survey lines also included in the intersection area 615 or 625), temporal biases can be introduced to the sensor data that is used to generate the mosaic image. For example, temporal biases such as tide and/or water velocities can cause errors and inaccuracies in the portion of the mosaic image generated using the sensor data collected in correspondence with the straight survey lines included in the intersection areas 615 and 625.

In some cases, beyond the resulting inaccuracies and complications in performing mosaicing for the overlapping portions 615 and 625 of the plurality of straight survey lines, it can be inefficient to perform the straight-line surveying depicted in FIG. 6 as each point of intersection included in the intersection areas 615 and 625 represents duplicated effort (e.g., if a portion of the seafloor is already surveyed by a previous straight survey line, it is inefficient, duplicative, and often unnecessary to survey that same portion of the seafloor with one or more additional straight survey lines). Time inefficiency may also result when performing the straight-line surveying depicted in FIG. 6 based on the time required not only to perform each of the individual straight survey lines included in the three sets 610, 620, 630, but also in the transition time required to maneuver the tow vessel to turn by 180-degrees between performing adjacent straight-line survey passes.

In one illustrative example, the systems and techniques described herein can be used to perform curved line surveying using one or more curved survey lines (also referred to as curved survey paths). For instance, using a towed platform surveying apparatus that includes an Attitude and Heading Reference System (AHRS) and/or a fiber optic gyroscope (FOG), sensor data (e.g., survey data) can be continuously collected along the curved line survey path 650 and correlated with heading information collected by the AHRS and/or FOG (e.g., correlated with heading information collected during the same subsurface deployment of the towed platform surveying apparatus as the sensor data/survey data). Based on the improved accuracy of the heading data obtained from the AHRS or FOG, the sensor data obtained along the curved line survey path 650 can be correlated to a common reference frame and/or reference coordinate system, such that the sensor data obtained at various points along curved line surveying path 650 can be analyzed as a single (e.g., combined) input to a mosaicing process.

In some embodiments, the systems and techniques can be used to correlate a plurality of surveying data inputs with a plurality of heading measurements. For instance, in some aspects a given surveying data input (e.g., included in the plurality of surveying data inputs) can be correlated with a corresponding heading measurement of the plurality of heading measurements that was obtained at the same point in time. For instance, the given surveying data input and the corresponding heading measurement determined from the correlation may be associated with the same common source or reference time stamp. In one illustrative example, the given surveying data input and the corresponding heading measurement determined from the correlation can be associated with the same pulse per second (PPS) signal associated with a global positioning system (GPS) synchronized to the collection of the surveying data inputs and the heading measurements.

In some examples, some (or all) of the plurality of surveying data inputs may be obtained using a sensing frequency that is different than (e.g., greater than or less than) a sensing frequency used to obtain the plurality of heading measurements. For instance, the plurality of surveying data inputs and the plurality of heading measurements may be collected asynchronously and/or using asynchronous sensing frequencies. For example, some (or all) of the plurality of surveying data inputs may be obtained using a sensing frequency of 5 Hertz (Hz) while the plurality of heading measurements may be obtained using a sensing frequency of 20 Hz. In one illustrative example, the plurality of surveying data inputs can include side-scan sonar data inputs obtained using a sensing frequency of 5 Hz while the plurality of heading measurements can be obtained from an FOG and/or ARHS using a sensing frequency of 20 Hz. In this example, because the 5 Hz sonar data frequency and the 20 Hz heading measurement data frequency are multiples of one another, a corresponding heading measurement may be obtained simultaneously or concurrently with each of the 5 sonar data inputs that are measured per second (e.g., assuming a common starting time of the side-scan sonar measurement and the heading measurement), and the correlation can be performed to identify the particular heading measurement that was obtained at the same time as each of the side-scan sonar data inputs.

In other examples, the surveying data inputs (e.g., side-scan sonar measurements) and the heading measurements may be obtained asynchronously, either based on different starting times being used for the side-scan sonar measurements and the heading measurements and/or based on the use of asynchronous sensing frequencies. For example, if the side-scan sonar measurements are obtained using a sensing frequency of 8 Hz and the heading measurements are obtained using a sensing frequency of 20 Hz, at least some of the side-scan sonar measurements are obtained at a point in time during which no corresponding heading measurement is obtained. In such examples, the systems and techniques described herein can correlate between the surveying data inputs and the heading measurements based on identifying the temporally adjacent or nearest heading measurement on either side of a given surveying data input (e.g., the heading measurements obtained immediately before and after the given surveying data input, in time). In one illustrative example, the systems and techniques can interpolate between the first (e.g., temporally prior) adjacent heading measurement and the second (e.g., temporally subsequent) adjacent heading measurement in order to generate an interpolated heading measurement that correlates with the given surveying data input. For example, a linear interpolation can be performed between the first adjacent heading measurement obtained at a first time and the second adjacent heading measurement obtained at a second time, in order to thereby determine an interpolated heading measurement for an intermediate time (e.g., the time at which the given surveying data input was obtained) that falls between the first time and the second time.

In some aspects, the systems and techniques described herein can be seen to provide efficiency gains and time savings of 20-30%, or greater, in comparison to conventional approaches such as the straight-line surveying sets 610, 620, 630 depicted in FIG. 6 (e.g., with the efficiency and time savings based at least in part on the quantity of turns needed to perform the plurality of straight-line surveys using the conventional approach).

In one illustrative example, multiple geophysical sensors can simultaneously collect survey data along the curved line survey path 650, with the sensor data from each sensor referenced to the same common reference heading data from the AHRS and/or FOG (e.g., AHRS and/or FOG included on the same towed platform as the multiple geophysical sensors). In some examples, the multiple geophysical sensors included on the towed platform survey apparatus can include one or more of a side-scan sonar array, a transverse gradiometer array, a high-resolution (and/or ultra-high resolution) seismic sensor array, a multi-beam sensor array, a sub-bottom profiler array, a water velocity sensor array, and/or an Acoustic Doppler Current Profiler (ADCP) array, among various others. For instance, in the example of FIG. 6, the curved line survey path 650 is depicted in combination with multi-beam sensor data obtained along the curved line survey path 650 (e.g., wherein the multi-beam sensor data is correlated using common reference heading data from the AHRS and/or FOG included on the same towed platform as a sensor array including at least the multi-beam sensor(s)).

Based on referencing multiple geophysical sensors to the same underlying AHRS or FOG heading data as a common reference, accurate mosaic images can be generated that combine multiple different sources or sensor data (e.g., a mosaic can overlay a first type of sensor data with a second type of sensor data, based on the first and second sensor being used to simultaneously obtain data along the curved line surveying path 650 and based on the first and second sensor both being referenced to the same underlying/ground-truth heading information from the AHRS or FOG).

Additionally, because the curved line surveying path 650 can be performed to obtain survey data in a single pass (e.g., as opposed to the plurality of straight-line survey passes associated with existing approaches), the presently disclosed curved line surveying can be used to survey and generate mosaic images for smaller (e.g., tighter) corridors than were previously possible when a plurality of straight-line survey passes were required. For example, the presently disclosed curved line surveying can be used to survey and generate mosaic images for cable and pipeline routes that pass through much smaller corridors of the seafloor, including cable and pipeline routes that previously could not be surveyed with the existing straight line survey approaches noted above. These smaller surveying corridors can be seen to directly translate into cost savings and project time compression associated with the curved line surveying (e.g., associated with the curved line survey path 650). The reduction from a plurality of straight-line survey paths (e.g., as depicted in FIG. 6) to a lesser quantity of curved line survey paths (e.g., such as curved line survey path 650, also depicted in FIG. 6) can further be seen to reduce the post-processing computational workload and/or interpretation time associated with generating mosaic images. In some examples, a plurality of straight-line survey paths can be replaced with multiple curved line survey paths (e.g., such as curved line survey path 650) of a lesser total quantity. In some examples, a plurality of straight-line survey paths can be replaced with a single curved line survey path (e.g., such as the curved line survey path 650). For instance, as described above, the conventional approaches based on straight line surveying may require an order of magnitude greater quantity of survey lines to survey the area that may be surveyed by a single curved line survey path 650.

Further still, the AHRS or FOG heading data associated with the curved line surveying path 650 can be used to generate highly accurate representations of the seafloor and target objects located thereon, along the continuous length of the curved line survey path 650. For example, the AHRS or FOG heading data can be seen to greatly improve side-scan sonar-based target location, particularly in rock fields (e.g., thereby reducing or eliminating the presence of duplicate objects, such as the duplicate objects 530a and 530b in FIG. 5). Improved target locations along the curved line surveying path 650 can still further be used to determine more accurate target object counts (e.g., more accurate rock counts) to better and more accurately characterize the nature of the seafloor along the curved line surveying path 650.

### Example Computing System

Turning now to the computing system 700, as illustrated for example in FIGS. 2-4, the computing system 700 can be communicatively coupled to the towed apparatus 102 such that the computing system 700 can receive data from the side-scan sonar device 104 and the gyroscopic sensor array 106. In some embodiments, a wired connection can be provided between the computing system 700 and the towed apparatus 102 (e.g., between the computing system 700, and the side-scan sonar device 104 and the gyroscopic sensor array 106). For instance, the wired connection can be carried via one or more communication cables provided on or otherwise attached to the tether connected the towed apparatus 102 to the tow vessel. In some embodiments, a wireless connection can additionally, or alternatively, be utilized for communications between the computing system 700 and the towed apparatus 102 (e.g., between the computing system 700, and the side-scan sonar device 104 and the gyroscopic sensor array 106). The communication link(s) can be unidirectional or bidirectional. In some aspects, after receiving data from the towed apparatus 102 (e.g., from side-scan sonar device 104 and/or gyroscopic sensor array 106), the computing system 700 can log the data. Subsequently, the computing system 700 can perform one or more mosaicing processes to jointly process the side-scan sonar data (side-scan sonar images from side-scan sonar device 104) with the heading information (e.g., FOG heading information from the gyroscopic sensor array 106). The mosaicing process(es) can be implemented by the computing system 700 to generate one or more composite (e.g., mosaiced) aerial images of the seafloor, as imaged by the side-scan sonar data. In particular, the highly accurate heading, roll, and pitch of the side-scan sonar device 104 can be determined from the gyroscopic information obtained by gyroscopic sensor array 106 and can be used to automatically guide the mosaicing process of aligning the separate side-scan sonar images (e.g., “tiles”) obtained by the side-scan sonar device 104 at different times and corresponding to different physical locations/scan areas.

In some embodiments, the computing system 700 can receive data from the gyroscopic sensor array 106 that includes heading data (e.g., rotation about heading axis HAG), roll data (e.g., rotation about roll axis RAG), and pitch data (e.g., rotation about pitch axis PAG). The computing system 700 can process the data received from the gyroscopic sensor array 106 to determine the heading, roll, and pitch of the side-scan sonar device 104 (e.g., rotation about heading axis HAS, rotation about roll axis RAS, and rotation about pitch axis PAS) during the survey.

FIG. 7 illustrates a computing system architecture, according to some embodiments of the present disclosure. Components of computing system architecture 700 are in electrical communication with each other using a connection 705. Connection 705 can be a physical connection via a bus, or a direct connection into processor 710, such as in a chipset architecture. Connection 705 can also be a virtual connection, networked connection, or logical connection.

In some embodiments, computing system 700 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 700 includes at least one processing unit (CPU or processor) 710 and connection 705 that couples various system components including system memory 715, such as read-only memory (ROM) 720 and random-access memory (RAM) 725 to processor 710. Computing system 700 can include a cache of high-speed memory 712 connected directly with, in close proximity to, or integrated as part of processor 710.

Processor 710 can include any general-purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms known to those of skill in the art. In some instances, multimodal systems can enable a user to provide multiple types of input/output to communicate with computing system 700. Computing system 700 can include communications interface 740, which can generally govern and manage the user input and system output. There is no restriction on operating on any hardware arrangement, and therefore the basic features here may easily be substituted for improved hardware or firmware arrangements as they are developed.

Storage device 730 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 730 can include software services, servers, services, etc., that when the code that defines such software is executed by the processor 710, it causes the system to perform a function. In some embodiments, a hardware service that performs a particular function can include the software component stored in a computer-readable medium in connection with the necessary hardware components, such as processor 710, connection 705, output device 735, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general-purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

While the present disclosure has been described with reference to various embodiments, it will be understood that these embodiments are illustrative and that the scope of the disclosure is not limited to them. Those skilled in the art will appreciate that variations from the specific embodiments disclosed above are contemplated by the invention. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

1. A method comprising:
obtaining a plurality of surveying data inputs from one or more sensors of a towed sensing apparatus, wherein the plurality of surveying data inputs is obtained during a subsurface deployment of the towed sensing apparatus along a curved survey path and are indicative of a seafloor measurement;
obtaining a plurality of heading measurements, each heading measurement of the plurality of heading measurements indicative of an angular direction of the towed sensing apparatus,
wherein the plurality of heading measurements and the plurality of surveying data inputs are measured during the subsurface deployment of the towed sensing apparatus;
correlating the plurality of surveying data inputs with the plurality of heading measurements; and
generating a composite image of an area of seafloor along the curved survey path, based on the plurality of surveying data inputs and the correlated heading measurements.

2. The method of claim 1, wherein the plurality of surveying data inputs is obtained based on towing the towed sensing apparatus along the curved survey path in a single continuous pass.

3. The method of claim 1, wherein correlating the plurality of surveying data inputs with the plurality of heading measurements comprises:
correlating each surveying data input of the plurality of surveying data inputs with a corresponding heading measurement of the plurality of heading measurements.

4. The method of claim 3, wherein correlating each surveying data input with a corresponding heading measurement comprises:
identifying a particular heading measurement of the plurality of heading measurements as being associated with a same point in time as a respective surveying data input of the plurality of surveying data inputs; or
generating an interpolated heading measurement for the respective surveying data input based on interpolating between a first heading measurement of the plurality of heading measurements that is temporally adjacent to and obtained prior to the respective surveying data input and a second heading measurement of the plurality of heading measurements that is temporally adjacent to and obtained subsequent to the respective surveying data input.

5. The method of claim 1, wherein the plurality of heading measurements is obtained using a gyroscopic sensor array coupled to the towed sensing apparatus.

6. The method of claim 5, wherein the gyroscopic sensor array comprises one or more of a fiber optic gyroscope (FOG) or a ring laser gyroscope (RLG).

7. The method of claim 1, wherein the plurality of heading measurements is obtained using an Attitude and Heading Reference System (AHRS) coupled to the towed sensing apparatus.

8. The method of claim 1, wherein the composite image is a mosaic image of the area of seafloor along the curved survey path.

9. The method of claim 1, wherein generating the composite image of the area of seafloor is based on aligning the plurality of surveying data inputs to a common reference based on the correlated heading measurements.

10. The method of claim 1, wherein the plurality of surveying data inputs is a plurality of side-scan sonar measurements obtained from a side-scan sonar array coupled to the towed sensing apparatus.

11. The method of claim 1, wherein:
the towed sensing apparatus includes a plurality of different sensors; and
the plurality of different sensors includes one or more of a side-scan sonar array, a transverse gradiometer array, a seismic sensor array, a sub-bottom profiler array, a water velocity sensor array, or an Acoustic Doppler Current Profiler (ADCP) array.

12. The method of claim 1, wherein the plurality of surveying data inputs includes a first subset of surveying data inputs obtained using a first sensor type and a second subset of surveying data inputs obtained using a second sensor type.

13. The method of claim 2, wherein generating the composite image of the area of seafloor comprises:
correlating the first subset of surveying data inputs with the plurality of heading measurements and correlating the second subset of surveying data inputs with the plurality of heading measurements, wherein the first subset and the second subset are associated with the same correlated heading measurements; and
generating the composite image of the area of seafloor based on aligning the first subset of surveying data inputs and the second subset of surveying data inputs using the same correlated heading measurements.

14. The method of claim 1, wherein:
the curved survey path is associated with a first distal end and a second distal end opposite from the first distal end, the first distal end and the second distal end defining a longitudinal axis of the curved survey path; and
a displacement of the curved survey path from the longitudinal axis varies along the length of the longitudinal axis from the first distal end to the second distal end.

15. A system comprising:
at least one processor; and
a memory storing instructions which when executed by the at least one processor, causes the at least one processor to:
obtain a plurality of surveying data inputs from one or more sensors of a towed sensing apparatus, wherein the plurality of surveying data inputs is obtained during a subsurface deployment of the towed sensing apparatus along a curved survey path and are indicative of a seafloor measurement;
obtain a plurality of heading measurements, each heading measurement of the plurality of heading measurements indicative of an angular direction of the towed sensing apparatus, wherein the plurality of heading measurements and the plurality of surveying data inputs are measured during the subsurface deployment of the towed sensing apparatus;
correlate the plurality of surveying data inputs with the plurality of heading measurements; and
generate a composite image of an area of seafloor along the curved survey path, based on the plurality of surveying data inputs and the correlated heading measurements.

16. The system of claim 15, wherein the plurality of surveying data inputs is obtained based on towing the towed sensing apparatus along the curved survey path in a single continuous pass.

17. The system of claim 15, wherein, to correlate the plurality of surveying data inputs with the plurality of heading measurements, the instructions cause the at least one processor to:
correlate each surveying data input of the plurality of surveying data inputs with a corresponding heading measurement of the plurality of heading measurements.

18. The system of claim 17, wherein, to correlate each surveying data input with a corresponding heading measurement, the instructions cause the at least one processor to:
identify a particular heading measurement of the plurality of heading measurements as being associated with a same point in time as a respective surveying data input of the plurality of surveying data inputs; or
generate an interpolated heading measurement for the respective surveying data input based on interpolating between a first heading measurement of the plurality of heading measurements that is temporally adjacent to and obtained prior to the respective surveying data input and a second heading measurement of the plurality of heading measurements that is temporally adjacent to and obtained subsequent to the respective surveying data input.

19. The system of claim 5, wherein the plurality of heading measurements is obtained using a gyroscopic sensor array coupled to the towed sensing apparatus.

20. The system of claim 19, wherein the gyroscopic sensor array comprises one or more of a fiber optic gyroscope (FOG) or a ring laser gyroscope (RLG).

21. (canceled)
